(19) United States
(12) Patent Application Publication
(10) Pub. No.: US 2007/0106797 A1
(43) Pub. Date: May 10, 2007

(54) Mission goal statement to policy statement translation

(75) Inventors: Franco Travostino, Arlington, MA (US); Bruce Schofield, Tyngsboro, MA (US); Inder Monga, Acton, MA (US)

Correspondence Address: McGUINNESS & MANARAS LLP, 125 NAGOG PARK, ACTON, MA, 01720, US

(73) Assignee: Nortel Networks Limited

(21) Appl. No.: 11/469,416

(22) Filed: Aug. 31, 2006

Related U.S. Application Data
(60) Provisional application No. 60/721,757, filed on Sep. 29, 2005.

(51) Int. Cl. G06F 15/173

(52) U.S. Cl. 709/226

(57) ABSTRACT

A mechanism and framework is disclosed for translating high level goal statements to policy rules. In a first step, high level goal statements are translated to network services. In a second step, the network services are translated to network parameters. In a third step, the network parameters are translated to policy rules. The first step may be facilitated with Web Ontology Language (“OWL”) and semantic templates. Advantages of automated mission goal statement to policy statement translation for surveillance missions include more reliable and faster planning and allocation of resources in support of the missions. Further, dynamic allocation of network resources facilitates adapting to changing conditions and more graceful degradation in adverse circumstances. The need for subject matter experts is also expected to be mitigated.

### CROSS-REFERENCE TO RELATED APPLICATIONS

A claim of priority is made to U.S. Provisional Patent Application 60/721,757, filed Sep. 29, 2006, entitled MISSION-GRADE WORKFLOWS, which is incorporated herein by reference.

### FIELD OF THE INVENTION

This invention relates generally to the field of network communications, and more particularly to network resources that support surveillance missions.

### BACKGROUND OF THE INVENTION

Surveillance systems are utilized to counter threats such as criminal and terrorist activity. In a typical surveillance system a collection of sensors, often of different types, provides raw data to computing resources. The computing resources process the raw data to produce a result which is more useful to human beings or other applications. Unless the sensors have large memory capacity to store data, and the raw data is manually retrieved, a communication network transports data and commands between devices.

Allocation of network resources to support a surveillance system is a complex, manual process that requires technical expertise. The process is similar to network planning in the telecommunications field, where subject matter experts determine resource requirements and plan an appropriate deployment of those resources by mental estimate, manual calculation, or a combination of both. However, unlike planning a telecommunications network, planning a surveillance network may be acutely time-constrained, have greater risks associated with failure, and be in competition with other missions for scarce resource. Further complicating matters, a surveillance network is more likely to be subjected to dynamically changing conditions and requirements due to, for example, reduced offered load due to moisture, smoke, interference temperature, and jamming. A failure in resource allocation planning can manifest itself as missed targets resulting in cascading of risks, poor reaction to a mission's evolving circumstances, under- or mis-utilization of key resources, and performance degradation or partial failures which go unnoticed until a more complete failure occurs.

### SUMMARY OF THE INVENTION

In accordance with one embodiment of the invention, a method executed by at least one computing device for allocating resources to a surveillance mission which competes for resources with other missions, comprises the steps of: in a first step, translating high level goal statements to network services; in a second step, translating the network services to network parameters; and in a third step, translating the network parameters to policy rules.

In accordance with another embodiment of the invention, apparatus operative to allocate resources to a surveillance mission which competes for resources with other missions, comprises: a mission goal definition module and a goal-to-service translator module operative in combination to translate high level goal statements to network services; a constraint analyzer module operative to translate the network services to network parameters; and a policy engine module operative to translate the network parameters to policy rules.

Advantages of automated mission goal statement to policy statement translation include more reliable and faster planning and allocation of resources in support of surveillance missions. Further, dynamic allocation of network resources facilitates adapting to changing conditions and more graceful degradation in adverse circumstances. The need for subject matter experts is also expected to be mitigated.

### BRIEF DESCRIPTION OF THE FIGURES

FIGS. 1 and 2 are a block diagram of a system for mission goal statement to policy statement translation.

FIG. 3 is a flow diagram of an exemplary surveillance mission.

### DETAILED DESCRIPTION

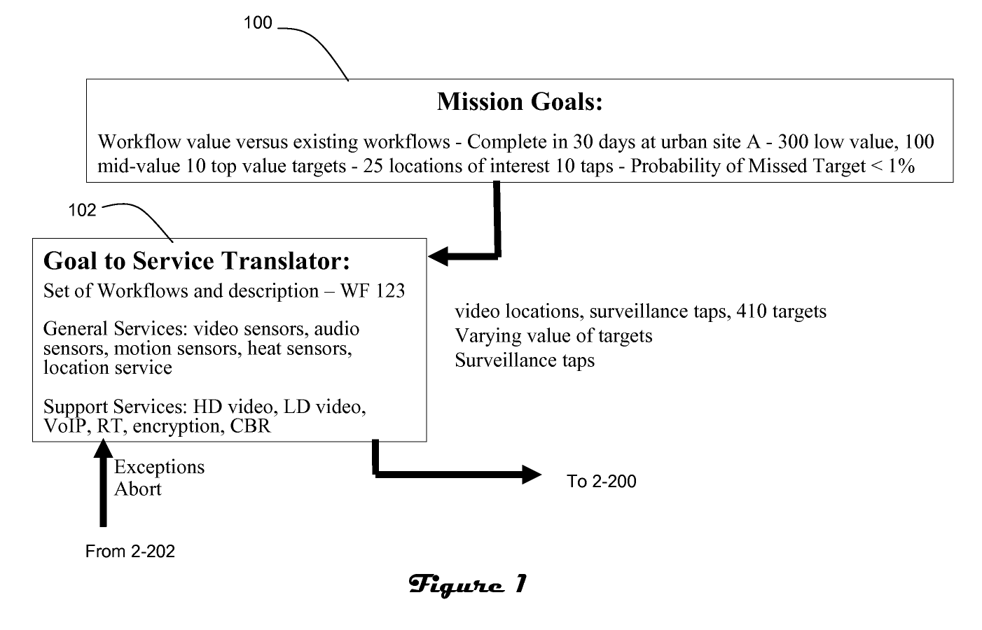

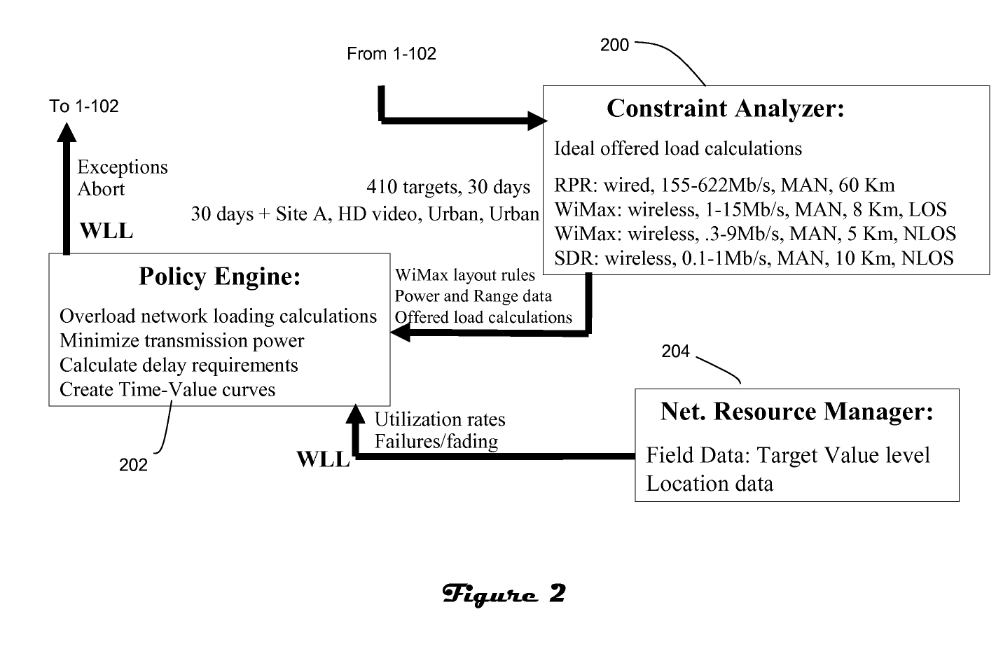

Referring now to FIGS. 1 and 2, a system for mission goal statement to policy statement translation includes a plurality of modules which may be implemented on one or more network devices, may include dedicated hardware, and may include software processes executed by one or more processors. In particular, the modules include a mission goal definition module (100), a goal-to-service translator module (102), a constraint analyzer module (200), a policy engine module (202), and a network resource manager (204). The system is operative to take high level goal statements as input, and create machine-friendly service templates, network properties and policy statements with which to execute surveillance missions.

The mission goal definition module (100) and goal-to-service translator (102) are operative in combination to translate high level goal statements to network services. User input from a command center is interpreted by the goal definition module to create a list of process constraints. Inputted data may be in the form of natural language, check boxes, fill-in-the-blanks, and responses to system questions. Individual portions of the inputted data are characterized as either a quantitative process constraint or qualitative process constraint. The constraints are then organized in terms of dependency relationships. In the illustrated example, the inputted data is “Complete in 30 days at urban site A—300 low value, 100 mid-value 10 top value targets—25 locations of interest 10 taps—Probability of Missed Target <1%.” The goal definition module parses the data and determines that “30 days” is a quantitative process constraint, “urban site A” is a qualitative process constraint, “300 low value, 100 mid-value 10 top value targets” are related quantitative process constraints, “25 locations” is a quantitative process constraint, “10 taps” is another quantitative process constraint, and “Probability of Missed Target <1%” is a qualitative process constraint. Having identified individual process constraints, categorized those constraints, and identified relationships and dependencies between those constraints, the goal definition module (100) provides the information to a goal-to-service translator module (102).

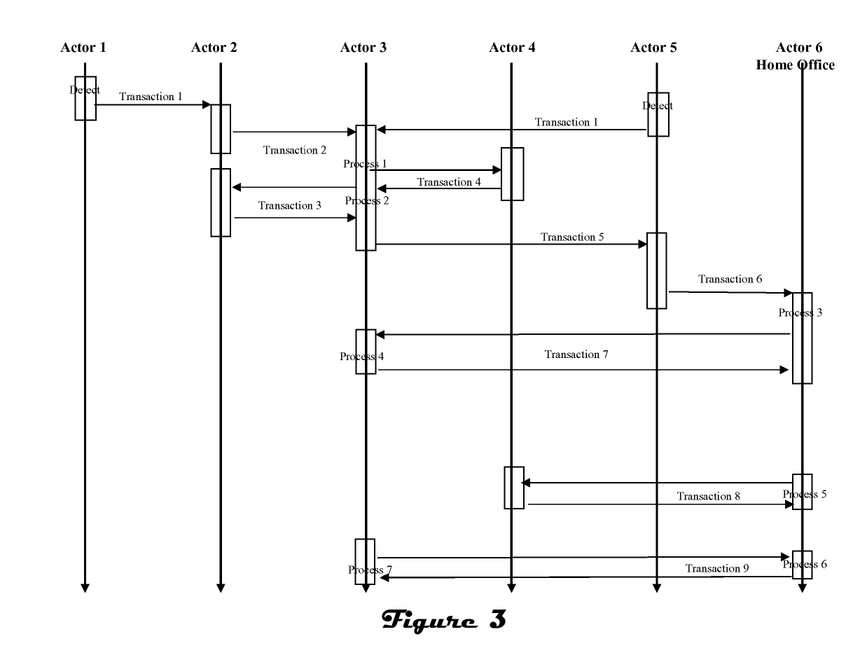

In response to the information received from the goal definition module, the goal-to-service translator module (102) associates a unique workflow descriptor with the information, e.g., WF 123. The goal-to-service translator then determines which services are required to support the workflow. This step may include a lookup in a database that specifies services required to meet particular constraints. In the case where alternative services may be used to meet a particular constraint, the goal-to-service translator initially selects only one of the services. The goal-to-service translator first determines which general services are required. In the illustrated example, video and audio sensors are required to obtain raw target identification information, motion and heat sensors are required to trigger the video and sound sensors, and a location service is required to associate data with one of the 25 locations. The goal-to-service translator then determines which support services are required based on both the constraints and the selected general services. In the illustrated example, high definition and low definition video signal service is selected for visual identification, supported with constant bit rate (“CBR”) service and encryption. Further, voice over Internet Protocol (“VoIP”) service is selected for transmission of the audio data from the audio sensors. The general a support services are added to the workflow information to provide an indication of data flows and device relationships such as illustrated in FIG. 3. That information is provided to the constraint analyzer module (200).

The constraint analyzer (200) is operative to translate network services to network parameters. In response to the workflow information provided by the goal-to-service translator, the constraint analyzer determines load calculation estimates, power and range data, and layout rules. In the illustrated example, 410 targets in 30 days leads to a calculation of 11 targets per day, and a known success rate of 5% leads to a calculation of 55 HD video transfers per day at 200 Mb/s, or 0.3 Mb per second on average. A library of resources such as wired networks, including a resilient packet ring and a single direction ring are selectable to deliver the aggregated sensor data flows to one or more data processing nodes. The constraint analyzer selects resources from the library of available resources, i.e., available in the sense that they are either installable upon request or at the disposal of the organization undertaking the surveillance, regardless of whether the resources are allocated to other missions. If adequate resources are not available, the constraint analyzer may suggest unavailable resource definitions. In the illustrated example, the RPR network from the library is eliminated as a possibility by the constraint analyzer because it would require more than 30 days to install (per information in the library). Consequently, wireless networks are selected for delivery of raw sensor data to aggregation points. The result is added to the workflow information and provided to a policy engine (202).

The policy engine (202) is operative to translate the network parameters to policy rules. In response to the workflow information provided by the constraint analyzer, the policy engine refines the resources now defined by the workflow information. In particular, the policy engine performs overload network loading calculations, determines minimum transmission powers, e.g., for the wireless communication links, calculates delay requirements, and generates Time-Value curves. The time value curves are described in co-pending U.S. patent application Ser. No. ______ filed ______, entitled ______, which is incorporated by reference. The policy engine may also utilize real-time or near real-time information about the network from the network resource manager (204) once the mission has commenced. In the illustrated example the network resource manager provides utilization rates and failures/fading information to the policy engine. Information from the network resource manager may be utilized to reallocate network resources to adapt to changing conditions. In particular, the changing conditions can be related to the mission itself, or the creation or deletion of a competing mission, e.g., with higher priority for the same resources. The output of the policy engine is an indication of whether the allocated resources are adequate to support the mission. This may be a simple binary indicator, or alternatively may specifically identify points of shortcoming and failure. This output is provided to the goal to service translator to prompt closed-loop reprocessing, and also to an execution engine so that the specified resources are allocated to the mission, if that has not already been done.

In an alternative embodiment Web Ontology Language (“OWL”) and semantic templates are employed to facilitate translation of mission goal statements to policy. In an example such as that described above where particular mission goal statements are matched with particular inputs requests, e.g., responding to questions or completing fields, a certain amount of subject matter expertise is required to match the appropriate mission goal statements with the appropriate input. Since some statements may be in the same units, e.g., time, a mistaken input could result in an output that, while erroneous, is difficult to detect. Owl and semantic templates can provide a more user-friendly tool which automates the process by identifying and classifying the mission goal statements from relatively plain language. In accordance with this embodiment the tool could search a plain language input for keywords related to time such as “seconds,” “minutes,” “days,” “months” and “years.” Further, the mission goal statements from the plain language may be soft, e.g., meaning “instant,” “interval,” “temporal,” “event,” by using word searches for “begins,” “ends,” “inside,” “after,” “overlap.” This could permit use of soft mission goal statements, e.g., “soon” as a time. The mission goal statements might be obtained via the techniques described in Time in OWL-S, Feng Pan and Jerry R. Hobbs, University of Southern California/Information Sciences Institute (2004), attached as Appendix A, and The METEOR-S Approach for Configuring and Executing Dynamic Web Processes, Kunal Verma, Karthik Gomadam, Amit P. Sheth, John A. Miller, Zixin Wu LSDIS Lab, University of Georgia (2005), attached as Appendix B.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method executed by at least one computing device for allocating resources to a surveillance mission which competes for resources with other missions, comprising the steps of:
in a first step, translating high level goal statements to network services;
in a second step, translating the network services to network parameters; and
in a third step, translating the network parameters to policy rules.

2. The method of claim 1 wherein the first step includes interpreting user input to produce process constraints with Web Ontology Language (“OWL”) and semantic templates.

3. The method of claim 2 wherein the first step includes characterizing individual portions of inputted data as either a quantitative process constraint or qualitative process constraint.

4. The method of claim 3 wherein the first step includes organizing the constraints in terms of dependency relationships.

5. The method of claim 3 wherein the first step includes associating a unique workflow descriptor with the mission.

6. The method of claim 5 wherein the first step includes determining which general services are required, and then determining which support services are required based on both the constraints and the selected general services.

7. The method of claim 1 wherein the second step includes determining load calculation estimates, power and range data, and layout rules.

8. The method of claim 1 wherein the third step includes performing overload network loading calculations, determines minimum transmission powers, and calculating delay requirements.

9. The method of claim 1 wherein the third step includes generating time-value curves.

10. Apparatus operative to allocate resources to a surveillance mission which competes for resources with other missions, comprising:
a mission goal definition module and a goal-to-service translator module operative in combination to translate high level goal statements to network services;
a constraint analyzer module operative to translate the network services to network parameters; and
a policy engine module operative to translate the network parameters to policy rules.

11. The apparatus of claim 10 wherein the mission goal definition module interprets user input to produce process constraints with Web Ontology Language (“OWL”) and semantic templates.

12. The apparatus of claim 11 wherein the mission goal definition module characterizes individual portions of inputted data as either a quantitative process constraint or qualitative process constraint.

13. The apparatus of claim 12 wherein the mission goal definition module organizes the constraints in terms of dependency relationships.

14. The apparatus of claim 12 wherein the goal-to-service translator module associates a unique workflow descriptor with the mission.

15. The apparatus of claim 14 wherein the goal-to-service translator is operative to determine which general services are required, and then determine which support services are required based on both the constraints and the selected general services.

16. The apparatus of claim 10 wherein the constraint analyzer is operative to determine load calculation estimates, power and range data, and layout rules.

17. The apparatus of claim 10 wherein the policy engine is operative to perform overload network loading calculations, determine minimum transmission powers, and calculate delay requirements.

18. The apparatus of claim 10 wherein the policy engine is operative generate time-value curves.
